(19) United States
(12) Patent Application Publication
(10) Pub. No.: US 2012/0170119 A1
(43) Pub. Date: Jul. 5, 2012

(54) DEFOGGING AND DEFROSTING DEVICE FOR PROTECTIVE LENS OF A CAMERA

(76) Inventors: Yi-Chih CHU, Taoyuan County (TW); Ching-Chung Hung, New Taipei (TW)

(21) Appl. No.: 13/174,097

(22) Filed: Jun. 30, 2011

(30) Foreign Application Priority Data
Jan. 4, 2011 (TW) 100200062

(51) Int. Cl. G03B 17/00

(52) U.S. Cl. 359/512

(57) ABSTRACT

The present invention relates to a defogging and defrosting devices for the protective lens of camera, which includes a heater that is coupled to a control circuit panel, a thermal gasket that is in contact contacting with the heater, receives the heat from the heater and transmits the heat to the glass or mirror object which contacts with in order to avoid and prevent the loss of lucidity of the glass or mirror object due to humidity. The defogging and defrosting device is installed on the body of the camera instead of on the protective lens in order to avoid shading the camera view and to facilitate the removal of protective lens while adjusting the focus of the camera. It also facilitates the replacement of the protective lens of the camera.

### BACKGROUND

1. Field of the Invention

The present invention relates to a defogging and defrosting technology for glass object or mirror object using electric heating. To be more precise, it relates to a defogging and defrosting device for cameras.

2. Description of the Related Art

Image clarity is ultimately one of the main elements to evaluate the performance of photographic equipments or monitor devices. Improving the optical components can effectively increase the image clarity. However the lucidity of the transparent protective lens installed in front of the camera affects significantly the clarity of the image. This transparent protective lens is installed in front of the protective shell of the camera and has an adequate distance from the camera lens. The factors that affect the lucidity of the transparent protective lens include mist, vapor and frost. These factors will make the protective lens lose its lucidity and also make the images captured by the camera blurred.

It is known that applying heating techniques on glass or mirror can solve the problem of lucidity loss caused by mist, vapor or frost. These techniques are often used on the glass of vehicles and buildings, glass of cupboards and the mirrors of bathroom equipments and have indeed the effect of keeping the lucidity of glass or mirrors. Relative literatures can be found in Taiwan Utility Model Patent No. M020497, M255611, M258270 and M304054

The dehumidification and defogging technologies for protective lens of camera are disclosed in Taiwan Utility Model Patent No. M276220 and M284917, as well as in Taiwan invention patent No. 201018949.

In Patent No. M276220, the light-emitting device of the monitor camera generates hot air that is transmitted to the protective lens in order to eliminate the humidity and fog on the protective lens. However, the monitor cameras nowadays use mostly LED as the light-emitting device that generates little heat and can hardly heat the air inside the camera to the temperature enough to eliminate the humidity on the protective lens. Furthermore, the transmission and convection of hot air are hard to control effectively to take effect on the protective lens and restore the lucidity of the humid protective lens. Also, in order to save power and extent the life of the light-emitting devices, the light-emitting devices are usually set to be in function only in the night and the problem of frost and fog on the protective lens can thus not be solved timely and effectively.

In Patent No. M284917, a heating ring is in direct contact with the protective lens and raises the temperature of the protective lens while functioning. The heater generates heat quickly on the central part of the protective lens which results in a rapid increase of temperature in the central area. However, due to the thermal conductivity of glass media, the temperature doesn't increase rapidly beyond the central area. The large thermal difference between the central and outer areas of the protective lens would probably result in fractures due to thermal expansion. The heater, exposed to the air, would get oxidized easily and thus reduce its life. Also, attaching directly on the protective lens, the heater will fog the plastic protective lens due to local heating. Moreover, the view of the camera will be shaded by the heater attached to the protective lens. When proceeding camera lens adjustment or focus control which requires the removal of protective lens, the heater interferes and limits the removal of the protective lens and hinders the replacement of protective lens of the camera.

In Patent No. 201018949, a conductive film is used as a heating element and is attached on the protective lens for dehumidification by heating. The said conductive film is composed of two insulating layers with metallic silver coating film electrode and carbon conductive film at inner part. Dehumidification of glass or mirror using conductive films can be found in literatures such as U.S. Patent No. U.S. Pat. No. 5,671,483, U.S. Pat. No. 5,806,102 and U.S. Pat. No. 5,845,342. In those literatures, the conductive films are used on the wind screen of helmets. However, the high cost of conductive film and the special process needed to be apply on the protective lens don't correspond to the manufacture cost of the camera.

And again, when proceeding camera lens' adjustment or focus control which requires the removal of protective lens, the heater interferes and limits the removal of the protective lens and hinders the replacement of protective lens of the camera.

### SUMMARY

The present invention is to solve the problem of loss of lucidity due to the humidity on the protective lens of cameras.

To solve the above mentioned problem, the present invention relates to the installation of a defogging and defrosting device on the case of the camera near the protective lens. The heat generated from the heater of the defogging and defrosting device is conducted to the protective lens via a heat-conducting gasket that is in directly contact with the protective lens. The protective lens can thus be heated or kept at a preset temperature to avoid or eliminate humidification or fog.

Furthermore, a control circuit panel decides whether to start the defogging and defrosting device upon the surrounding temperature detected by a temperature detector. The temperature detector is programmed with a preset temperature (e.g. 0° C.) to activate the heater. The temperature detector detects the surrounding temperature and activate the heater using the control circuit panel when the surrounding temperature attains or is below the preset temperature in order to avoid or eliminate humidification or fog.

The effects of the present invention include:

Avoiding and eliminating humidification or fog on the protective lens, restore the lucidity of the protective lens thus maintaining the image clarity of the camera.

Using the thermal gasket to transmit the heat gradually from the heater to the protective lens that allows a progressive heating on the protective lens in order to prevent the thermal shock between the heating part of the protective lens and the heater and protect the protective lens from fracture due to the difference of temperature while defogging.

Using the thermal gasket to transmit the heat from the heater evenly to the protective lens in order to allow an uniform heating of the protective lens.

Using the temperature detector to detect the surrounding temperature and activate the heater at an adequate timing in order to provide instant defogging and defrosting and decrease the consumption of electricity.

The defogging and defrosting device is installed on the body of the camera instead of on the protective lens in order to avoid shading the camera view and to facilitate the removal of protective lens while adjusting the focus of the camera. It also facilitate the replacement of the protective lens of the camera.

### DETAILED DESCRIPTION

For describing the main idea of the present invention as the summary mentioned above, the following preferred embodiment is illustrated. It is necessary to mention that the different elements in the preferred embodiment are drawn for explaining the ratio, size, deformation or displacement and are not drawn proportionally to the real element. Furthermore, similar elements are designated identical number in the following description.

FIG. 1 and FIG. 2 disclose the main elements of the defogging and defrosting device (1) of the present invention. The defogging and defrosting device (1) is built in a camera. While a monitor camera is used to describe the present invention in the embodiment, the application of the invention is not limited to monitor cameras. The defogging and defrosting device (1) of the present invention includes a heater (10), a thermal gasket (20) and a control circuit panel (30). The shapes of elements in the drawings are only for illustration. In the reality, the elements can be of different geometries according to the structure of cameras that they are coupled to. In the embodiment of the present invention, the heater (10) is a continuous sheet of metal with an impedance value or a soft PCB board with its two ends as contact jaws connecting respectively to a conductor (11) with its other end assembling collectively to a plug (12) and the plug (12) is coupled to the control circuit panel (30). The control circuit panel (30) is coupled to a temperature detector (35) and a power device (not shown). The power device supplies the electricity needed for the defogging and defrosting device (1) to function. The temperature detector (35) detects the surrounding temperature and sends the temperature signal to the control circuit panel (30). The control circuit panel (30) compares the detected temperature with the preset temperature. When the detected temperature reaches the preset temperature or is lower than the preset temperature, the control circuit panel (30) activates the circuit of the heater (10) which generates heat till the present temperature is reached. The above-mentioned thermal gasket (20) is a sheet insulator with high thermal conductivity that is in directly contact to the heater (10) in order to receive the heat generated by the heater (10) and transmit the heat to the object that it is in contact to. In the embodiment of the present invention, the thermal gasket (20) is in contact with the protective lens of the camera. The above-mentioned preset temperature is the surrounding temperature of the location of the camera. Since the objective of the present invention is to avoid and prevent the humidification and fog on the protective lens of the camera, the preset temperature should be set according to the cause of the humidification and fog. For example, when humidification and fog occur to the protective lens when the surrounding temperature is 0° C. and the defogging and defrosting device (1) should be activated for dehumidification, the preset temperature should be set to 0° C.

In FIG. 3 to FIG. 6, the first embodiment of the present invention of defogging and defrosting device (1) is used on a bullet camera (50). The external structure of the bullet camera (50) includes a protective shell (51) and a planar protective lens (52) assembled to the front of the protective shell (51). The lens (53) of the camera and the light module (54) is mounted inside the protective shell (51). The light module (54) includes a control circuit panel (54) and a LED light (542) coupled to the control circuit panel (541).

In this embodiment, the protective lens (52) is planar and the heater (10) and thermal gasket (20) are flat annular. The heater (10) is set on the control circuit panel (541) and the thermal gasket (20) is contacting with the heater (10). A heat transfer element (55) is contacting with the thermal gasket (20) with its bottom and with the protective lens (52) with its top. In the drawings, the protective lens (52) are mounted with 2 concentric mirrors or glass (521, 522) and through the heat transfer element (55). The heat transfer element (55) is a annular insulator with high thermal conductivity that transmits the heat from the thermal gasket (20) to the protective lens (52).

As shown in FIG. 7 to FIG. 10, the second embodiment of the present invention, the defogging and defrosting device (1) is used on a dome camera (40). The external structure of the dome camera (40) includes a protective shell (41) and a semi-spherical protective lens (42) mounted at front of the protective shell (41). The lens (43) and light module (44) of the camera (40) are mounted inside the protective shell (41). The light module (44) includes a control circuit panel (44) and a LED light (442) coupled to the control circuit panel (441). A supporting element (45) is mounted with its bottom on the control circuit panel (441) of the light module (44). The defogging and defrosting device (1) is fixed on the supportive element (45). In this embodiment, the protective lens (42) is semi-spherical and the heater (10) and thermal gasket (20) are annular with the torus declining from the center toward the circumference at a preset angle. Corresponding slot (451) in designed at the top of the supporting element (45) to fix the heater (10) in the slot. As shown in the drawings, the thermal gasket (20) is in full fully contact with the inner side of the protective lens (42) in order to transmit the heat effectively to the protective lens (42).

As shown in FIG. 11 to FIG. 13, the third embodiment of the present invention, the defogging and defrosting device (1) is used on a dome camera (60). The external structure of the dome camera (60) includes a protective shell (61) and a semi-spherical protective lens (62) mounted at front of the protective shell (61). The lens (63) and focus device (64) of the camera (60) are mounted on a holder (65) inside the protective shell (61). Several cylindrical components (661) surround the lens (63) and the focus device (64) in a concentric way and have their bottoms mounted on a fixing element (67). An annular bracket (662) is set on the top of cylindrical components (661). The heater (10) of the defogging and defrosting device (1) is mounted at the inner wall of the annular bracket (662) and the thermal gasket (20) is mounted at the locating slot (663) on the top of the annular bracket (662). The annular bracket (662) is an insulator with high thermal conductivity that allows the heat generated by the heater (10) to be transmitted to the thermal gasket (20) which is fully in contact with the inner side of the protective lens (62) in order to transmit the heat effectively to the protective lens (62).

From the description above, it is known that the present invention relates to eliminate the loss of lucidity due to the fog, mist and frost by heating the protective lens of camera. The present invention of defogging and defrosting device can keep the protective lens at an adequate temperature and prevent the humidification from occurring on the protective lens for a long time. The function of activating the defogging and defrosting device upon the surrounding temperature allows instant elimination of existing humidification on the protective lens, restores the lucidity of the protective lens and maintains the clarity of image. Besides, via the above-mentioned thermal gasket, the heat generated by the heater is transmitted to the protective lens gradually that allows a progressive heating of the protective lens where, via the glass medium of the protective lens, the heat is diffused from the center area to the outer side and prevents the whole protective lens from humidification. The progressive heating can avoid the unbalanced temperature of the heating part and the other parts and also avoid the fractures due to the thermal expansion or the leaking resulting from the cracking of the glue part of the protective lens. The thermal gasket of the defogging and defrosting devices is annular in order to provide a uniform heat transmission from the heater to the protective lens thus allows a uniform heating of the protective lens. The control circuit of the above-mentioned defogging and defrosting device activates the heater upon the surrounding temperature detected by the temperature detector in order to make the dehumidification and defogging function at an adequate timing and reduce the electricity consumption.

The above-mentioned first, second and third embodiments are all illustrated as a defogging and defrosting device of a camera. However, the application of the present invention is not limited to them. Every kind and type of camera can be equipped with the defogging and defrosting device of the present invention. Besides, by the above-mentioned embodiments, it shows that the defogging and defrosting device of the present invention can be coupled with different types of cameras. As in the second and third embodiment, the defogging and defrosting device (1) of the present invention is installed in the camera as an assembled unit. The assembled unit is constituted of supporting element (45) in the second embodiment and several cylindrical elements (661) and annular bracket (662) in the third embodiment.

While this invention has been particularly shown and described with references to preferred embodiments thereof, it will be understood by those skilled in the art that various changes in form and details may be made therein without departing from the scope of the invention encompassed by the appended claims. Any modification or change not departing from the main idea of the present invention is within the scope of the patent claimed.

### BRIEF DESCRIPTION OF THE DRAWINGS

FIG. 1 is the exploded view of the main components of the defogging and defrosting device of the present invention.

FIG. 2 is the composite profile of the main components of the defogging and defrosting device of the present invention.

FIG. 3 is the external view of a bullet camera where the present invention of defogging and defrosting device can be installed.

FIG. 4 is the exploded view of the defogging and defrosting device of the present invention applied to a bullet camera.

FIG. 5 is the composite profile of the defogging and defrosting device of the present invention applied to a bullet camera.

FIG. 6 is the partial enlarged view of FIG. 5.

FIG. 7 is the external view of a dome camera where the present invention of defogging and defrosting device can be installed.

FIG. 8 is the exploded view of the defogging and defrosting device of the present invention applied to a dome camera.

FIG. 9 is the composite profile of the defogging and defrosting device of the present invention applied to a dome camera.

FIG. 10 is the partial enlarged view of FIG. 9.

FIG. 11 is the exploded view of the defogging and defrosting device of the present invention applied to a dome camera.

FIG. 12 is the composite profile of the defogging and defrosting device of the present invention applied to a dome camera.

FIG. 13 is the partial enlarged view of FIG. 12.

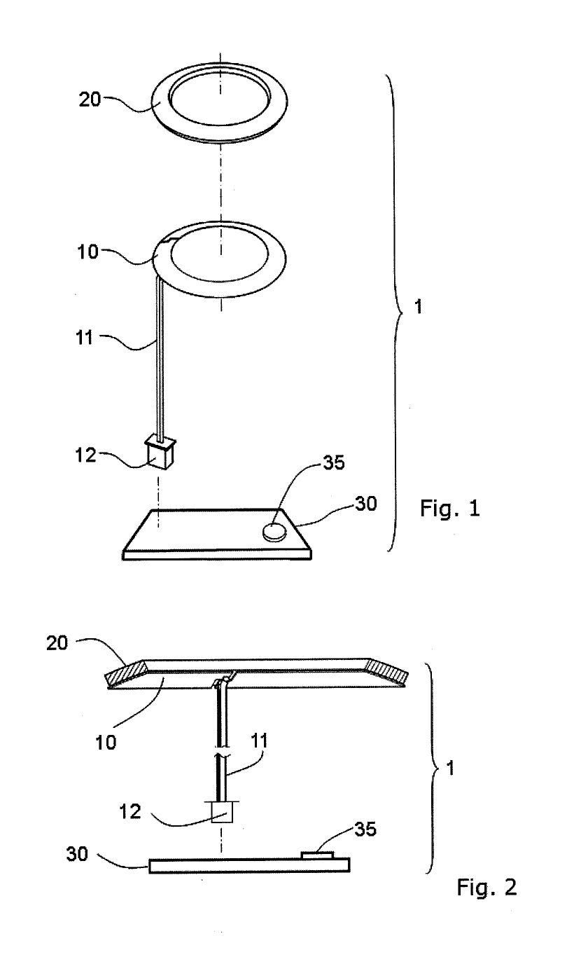

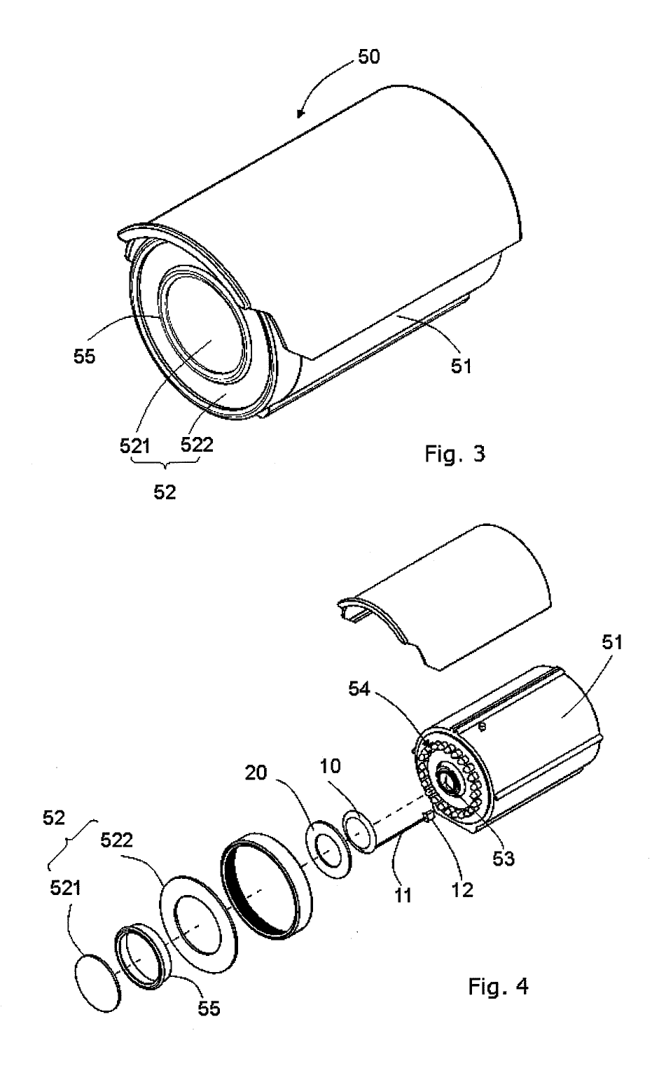

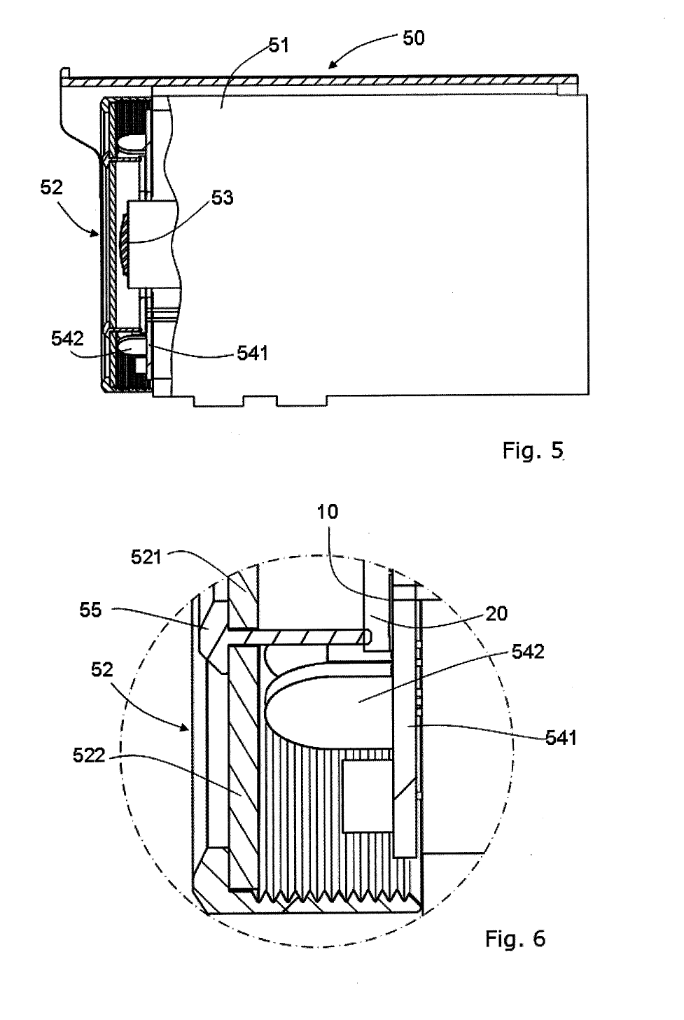

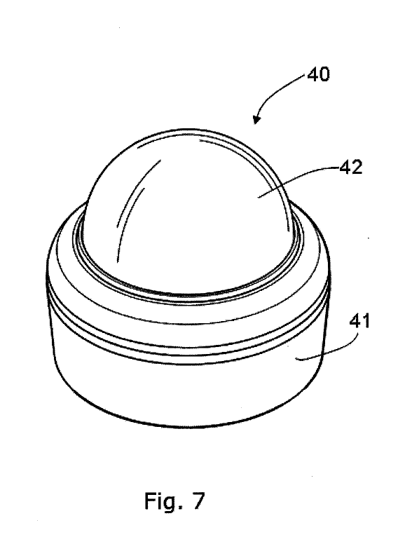

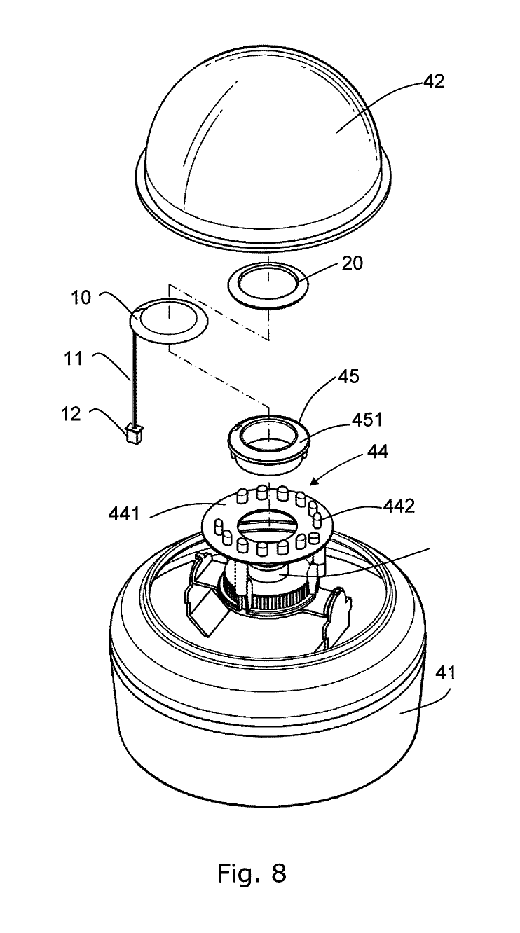

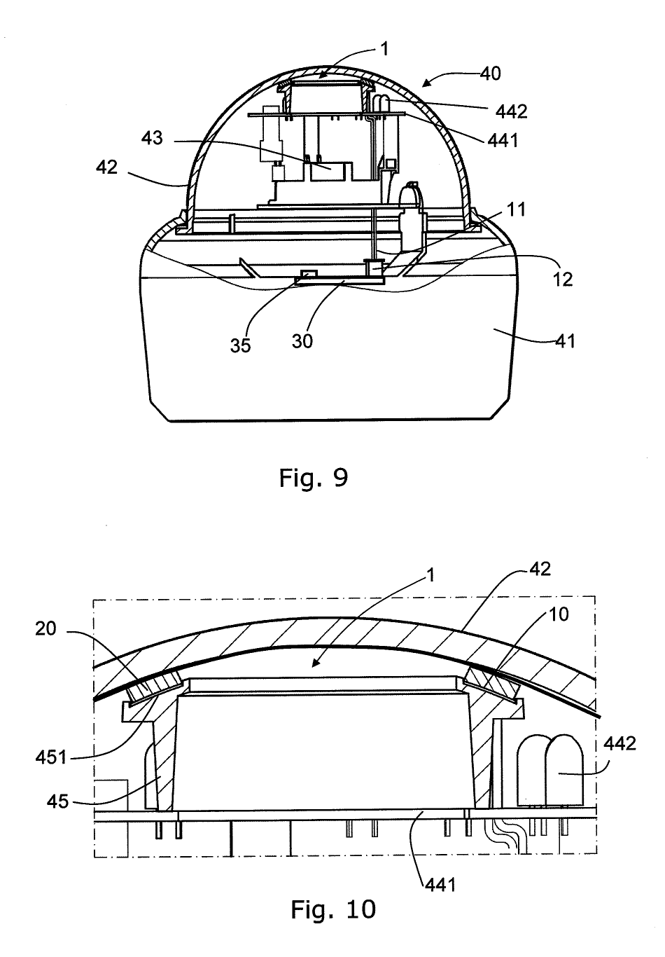

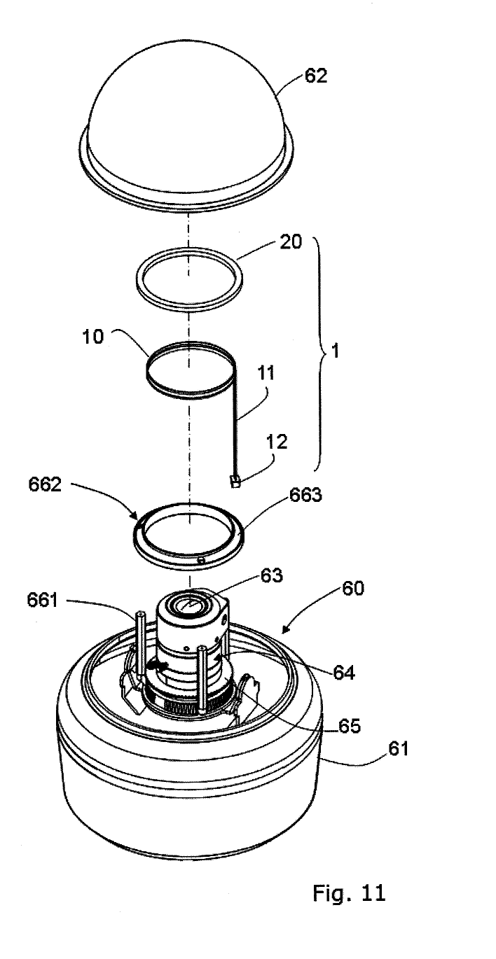

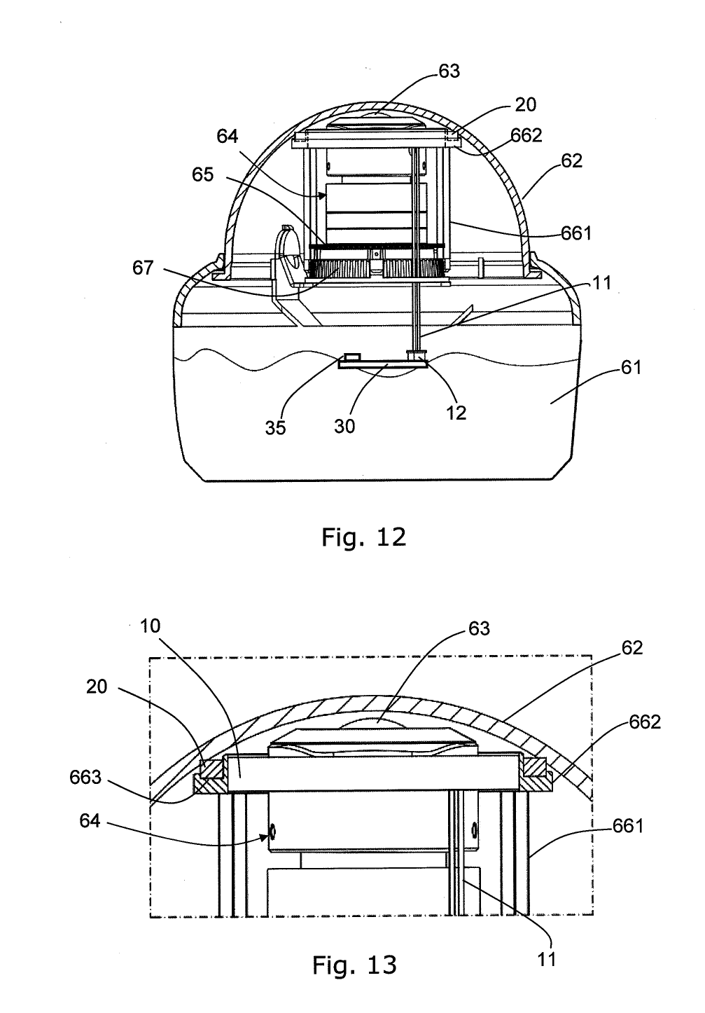

### DESCRIPTION OF MAIN COMPONENTS

1—defogging and defrosting device
10—heater
11—conductor
12—plug
20—thermal gasket
30—control circuit panel
35—temperature detector
40—dome camera
41—protective shell
42—protective lens
43—optical lens
44—light module
441—control circuit panel
442—LED light
45—supporting element
451—slot
50—bullet camera
51—protective shell
52—protective lens
521—mirror or glass object
522—mirror or glass object
53—optical lens
54—light module
541—control circuit panel
542—LED light
55—heat transfer element
60—dome camera
61—protective shell
62—protective lens
63—optical lens
64—focus device
65—holder
661—cylindrical elements
662—annular bracket
663—locating slot
67—fixing element

What is claimed is:

1. A defogging and defrosting devices for the protective lens of camera that includes:
A heater that is coupled to a control circuit panel;
A thermal gasket that is in contacting with the heater, receives the heat from the heater and transmits the heat to the glass or mirror object which contacts with in order to avoid and prevent the loss of lucidity of the glass or mirror object due to humidity.

2. A defogging and defrosting devices for the protective lens of camera as in claim 1 wherein the device includes furthermore a temperature detector that is coupled with the control circuit. The temperature detector provides the temperature signal upon which the control circuit panel decides whether to activate the heater.

3. A defogging and defrosting devices for the protective lens of camera as in claim 1 wherein the glass or mirror object is the protective lens of a camera.

4. A defogging and defrosting devices for the protective lens of camera as in claim 1 wherein the thermal gasket is made of an insulator with high thermal conductivity.

5. A defogging and defrosting devices for the protective lens of camera as in claim 1 wherein the heater and the thermal gasket are both annular.

6. A defogging and defrosting devices for the protective lens of camera as in claim 5 wherein the torus of the heater and the thermal gasket declines from the center toward the circumference at a preset angle.

7. A defogging and defrosting devices for the protective lens of camera as in claim 1 wherein the device includes furthermore a heat transfer component that are between and directly contact with the thermal gasket and the glass or mirror object.

8. A defogging and defrosting devices for the protective lens of camera as in claim 7 wherein the heat transfer component is made of an high thermal conductivity.

9. A defogging and defrosting devices for the protective lens of camera as in claim 1 wherein the device includes furthermore a mounting unit that allows the installation of the heater and the thermal gasket inside a camera and the full contact of the thermal gasket and the protective lens of the camera.

10. A defogging and defrosting devices for the protective lens of camera as in claim 9 wherein the mounting unit includes a supporting element which is to support the heater.

11. A defogging and defrosting devices for the protective lens of camera as in claim 9 wherein the mounting unit includes several cylindrical elements and an annular bracket mounted on top of the cylindrical elements.

12. A defogging and defrosting devices for the protective lens of camera as in claim 11 wherein the heater is fixed at the inner wall of the annular bracket and the thermal gasket is set in the locating slot on top of the annular bracket.
